(19) United States
(12) Patent Application Publication
(10) Pub. No.: US 2026/0351579 A1
(43) Pub. Date: Nov. 5, 2026

(54) POSITIVE ELECTRODE MIXTURE, LITHIUM ION BATTERY, POSITIVE ELECTRODE MIXTURE COMPOSITION, AND POSITIVE ELECTRODE MIXTURE PRODUCTION METHOD

(71) Applicant: IDEMITSU KOSAN CO.,LTD., Chiyoda-ku, Tokyo (JP)

(72) Inventors: Yuta FUJII, Chiyoda-ku, Tokyo (JP); Yamato HANIU, Chiyoda-ku, Tokyo (JP); Hiroyuki HIGUCHI, Chiyoda-ku, Tokyo (JP); Yu ISHIHARA, Chiyoda-ku, Tokyo (JP)

(73) Assignee: IDEMITSU KOSAN CO.,LTD., Chiyoda-ku, Tokyo (JP)

(21) Appl. No.: 19/099,994

(22) PCT Filed: Jul. 26, 2023
(86) PCT No.: PCT/JP2023/027338

§ 371 Date: Jan. 30, 2025

(30) Foreign Application Priority Data
Aug. 5, 2022 (JP) 2022-125206

(51) Int. Cl. H01M 4/38; H01M 4/02; H01M 4/04; H01M 10/0525; H01M 10/0562

(52) U.S. Cl. CPC H01M 4/38; H01M 4/0471; H01M 10/0525; H01M 10/0562; H01M 2004/028; H01M 2300/0068

(57) ABSTRACT

A positive electrode mixture including an elemental sulfur, a solid electrolyte, a conductive aid, and an organic compound capable of suppressing the vaporization of the elemental sulfur.

### TECHNICAL FIELD

The present invention relates to a positive electrode mixture, a lithium-ion battery, a composition for a positive electrode mixture, and a method for producing a positive electrode mixture. Specifically, the present invention relates to a positive electrode mixture capable of suppressing the vaporization of sulfur, a lithium-ion battery, a composition for a positive electrode mixture, and a method for producing a positive electrode mixture.

### BACKGROUND ART

As a positive electrode mixture used for a lithium-ion battery or the like, a sulfur-based positive electrode mixture having a higher theoretical capacity is known (Patent Document 1).

### RELATED ART DOCUMENTS

### Patent Documents

[Patent Document 1] WO 2012/086196 A1

### SUMMARY OF THE INVENTION

When a positive electrode sheet of a sulfur-based positive electrode mixture is produced, it is necessary to disperse the mixture in a solvent, to apply it, and then to conduct a drying operation.

However, since sulfur is vaporized in the case where the solvent is dried, it is considered that the amount of sulfur included in the positive electrode mixture is reduced to reduce the capacity per the mixture.

An object of the present invention provides a positive electrode mixture capable of suppressing the vaporization of sulfur, a lithium-ion battery, a composition for a positive electrode mixture, and a method for producing a positive electrode mixture.

As a result of intensive studies, the present inventors have found that the vaporization of the sulfur can be suppressed by a positive electrode mixture including a specific component, and have completed the present invention.

According to the present invention, the following positive electrode mixture and the like can be provided.
1. A positive electrode mixture comprising an elemental sulfur, a solid electrolyte, a conductive aid, and an organic compound capable of suppressing the vaporization of the elemental sulfur.
2. The positive electrode mixture according to 1, wherein the organic compound comprises N (nitrogen atom) and has an unshared electron pair.
3. The positive electrode mixture according to 1 or 2, wherein the organic compound is an amine.
4. The positive electrode mixture according to any one of 1 to 3, wherein the organic compound is an aliphatic amine.
5. The positive electrode mixture according to any one of 1 to 4, wherein the organic compound has a tertiary amino group.
6. The positive electrode mixture according to any one of 1 to 5, wherein the organic compound is tetramethylethylenediamine.
7. The positive electrode mixture according to any one of 1 to 6, wherein the solid electrolyte is a sulfide solid electrolyte.
8. A lithium-ion battery comprising the positive electrode mixture according to any one of 1 to 7.
9. A composition for a positive electrode mixture comprising an elemental sulfur, a solid electrolyte, a conductive aid, an organic compound capable of suppressing the vaporization of the elemental sulfur, and a solvent.
10. A method for producing a positive electrode mixture, comprising: heating the composition for the positive electrode mixture according to 9.

According to the present invention, it is possible to provide a positive electrode mixture capable of suppressing the vaporization of sulfur, a lithium-ion battery, a composition for a positive electrode mixture, and a method for producing a positive electrode mixture.

### BRIEF DESCRIPTION OF THE DRAWINGS

FIG. 1 is a diagram showing the results of the generated gas analysis.

### MODE FOR CARRYING OUT THE INVENTION

Hereinafter, a positive electrode mixture, a lithium-ion battery, a composition for a positive electrode mixture, and a method for producing a positive electrode mixture of the present invention will be described in detail.

The expression “x to y” as used herein represents the numerical range of “x or more, y or less”. An upper limit value and a lower limit value described for the numerical range may be arbitrarily combined.

### 1. Positive Electrode Mixture

The positive electrode mixture according to the present aspect includes an elemental sulfur, a solid electrolyte, a conductive aid, and an organic compound (herein, sometimes referred to as “organic compound α”) capable of suppressing the vaporization of the elemental sulfur.

According to the positive electrode mixture of the present aspect, the effect of suppressing the vaporization of the sulfur can be achieved. In addition, since the vaporization of the sulfur is suppressed, the decrease of the sulfur contained in the positive electrode mixture can be suppressed. In addition, since the vaporization of the sulfur is suppressed, corrosion of a manufacturing apparatus (particularly, a metal member) or the like caused by the sulfur-containing gas can be suppressed.

As described above, when a positive electrode sheet of a sulfur-based positive electrode mixture is produced, it is necessary to disperse the positive electrode mixture in a solvent, to apply it, and then to conduct a drying operation. In the present aspect, since the sulfur in the positive electrode mixture is captured to the organic compound α, it is possible to prevent the sulfur from being vaporized in the case where the solvent is dried by heat or the like.

The organic compound α is not particularly limited as long as it is an organic compound capable of suppressing the vaporization of the elemental sulfur.

S (sulfur atom) constituting the elemental sulfur has the same covalent property as that of N (nitrogen atom), and it tends to bear a negative charge. On the other hand, unlike N, it is a third period element, so that it is possible to use an empty 3d orbital and it is easy to accept a negative charge.

As the organic compound α, an organic compound capable of interacting with S (sulfur atom) can be given. Without being bound by theory, it is considered that, for example, when the organic compound has an electrically negative element, an unshared electron pair thereof interacts with an empty orbital of S (sulfur atom). As a result of such interactions, the vaporization of the elemental sulfur is suppressed.

In one embodiment, the organic compound α is a compound having an unshared electron pair.

In one embodiment, the organic compound α is a compound containing one or more members selected from the group consisting of N (nitrogen atom), O (oxygen atom) and a halogen atom.

In one embodiment, the organic compound α is a compound containing N (nitrogen atom) and having the unshared electron pair.

In one embodiment, the organic compound α is an amine (also referred to as “amine compound”), a nitrile (also referred to as “nitrile compound”) or an amide (also referred to as “amide compound”). These compounds can suitably suppress the vaporization of the elemental sulfur by combining with the elemental sulfur by a nucleophilic reaction or a similar reaction of a Willgerodt reaction.

In one embodiment, the organic compound α has a tertiary amino group. When the organic compound α has the tertiary amino group, the vaporization of the elemental sulfur can be suppressed more suitably. The organic compound α may have one tertiary amino group, or it may have two or more tertiary amino groups. The organic compound α preferably has two or more tertiary amino groups.

Examples of the amine include an aliphatic amine, an alicyclic amine, a heterocyclic amine, an aromatic amine, and the like, and it may be used alone, or a plurality of kinds thereof may be used in combination.

Specific examples of the aliphatic amine typically preferably include an aliphatic tertiary diamine such as N,N,N′, N′-tetramethyldiaminomethane, N,N,N′,N′-tetramethylethylenediamine, N,N,N′,N′-tetraethylethylenediamine, N,N,N′,N′-tetramethyldiaminopropane, N,N,N′,N′-tetraethyldiaminopropane, N,N,N′,N′-tetramethyldiaminobutane, N,N,N′,N′-tetramethyldiaminopentane and N,N,N′,N′-tetramethyldiaminohexane. In the examples in the present specification, unless otherwise specified, for example, in the case of diaminobutane, isomers relating to the position of amino group such as 1,2-bis(dimethylamino)butane, 1,3-bis(dimethylamino)butane, and 1,4-bis(dimethylamino)butane are included, as well as all isomers of butane such as linear and branched isomers.

The number of carbon atoms of the aliphatic amine is preferably 2 or more, more preferably 4 or more, and still more preferably 6 or more, and the upper limit thereof is preferably 10 or less, more preferably 8 or less, and still more preferably 7 or less. The number of carbon atoms of the hydrocarbon group of the aliphatic hydrocarbon group in the aliphatic tertiary amine preferably is 2 or more, and the upper limit thereof is preferably 6 or less, more preferably 4 or less, and still

Examples of the alicyclic amine typically preferably include an alicyclic tertiary diamine such as N,N,N′,N′-tetramethyl-cyclohexanediamine and bis(ethylmethylamino)cyclohexane, and examples of the heterocyclic amine typically preferably include a heterocyclic tertiary diamine such as N,N-dimethylpiperazine and bismethylpiperidylpropane.

The number of carbon atoms of the alicyclic amine and the heterocyclic amine are preferably 3 or more, and more preferably 4 or more, and the upper limit thereof is preferably 16 or less, and more preferably 14 or less.

Examples of the aromatic amine typically preferably include an aromatic tertiary diamine such as N,N-dimethylphenylenediamine, N,N,N′,N′-tetramethylphenylenediamine, N,N,N′,N′-tetramethyldiaminodiphenylmethane and N,N,N′,N′-tetramethylnaphthalenediamine.

The number of carbon atoms of the aromatic amines is preferably 6 or more, more preferably 7 or more, and still more preferably 8 or more, and the upper limit thereof is preferably 16 or less, more preferably 14 or less, and still more preferably 12 or less.

In one embodiment, the amine may be substituted by a substituent such as an alkyl group, an alkenyl group, an alkoxyl group, a hydroxyl group, a cyano group and a halogen atom.

Although the diamine is mainly exemplified in the specific example, it is not limited thereto, and a polyamine having three or more amino groups such as N,N,N′,N“,N”-pentamethyldiethylenetriamine, N,N′-bis[(dimethylamino)ethyl]-N,N′-dimethylethylenediamine and hexamethylenetetramine can also be used.

In one embodiment, the organic compound α is an aliphatic tertiary diamine having tertiary amino groups at both ends. As such the aliphatic tertiary diamine, tetramethylethylenediamine, tetraethylethylenediamine, tetramethyldiaminopropane, and tetraethyldiaminopropane are preferable.

The nitrile is not particularly limited, and examples thereof include a nitrile compound represented by R(CN)n. In the formula, Ris, for example, an alkyl group having 1 or more and 10 or less of carbon atoms, an alkoxyl group having 1 or more and 10 or less of carbon atoms or a group having an aromatic ring having 6 or more and 18 or less of ring carbon atoms. n is 1 or 2.

Specific examples of the nitrile include acetonitrile, methoxyacetonitrile, propionitrile, methoxypropionitrile, 3-chloropropionitrile, benzonitrile, 4-fluorobenzonitrile, tertiary-butyronitrile, isobutyronitrile, cyclohexylnitrile, capronitrile, isocapronitrile, malononitrile, fumaronitrile, isovaleronitrile, and the like.

In one embodiment, the organic compound α is a compound containing O (oxygen atom). Examples of the compound containing O (oxygen atom) include an ester, an ether, and a ketone.

In one embodiment, the organic compound α is a compound containing a halogen atom.

Examples of the halogen atom include a chlorine atom, a fluorine atom, a bromine atom, and an iodine atom.

Specific examples of the compound containing the halogen atom include an alkyl halide, an aryl halide, and the like.

The alkyl group in alkyl halide may have, for example, 1 or more and 10 or less of carbon atoms.

The aryl group in aryl halide may have, for example, 6 or more and 18 or less of ring carbon atoms.

The organic compound α may be an organic compound other than the compound described above. Examples of such organic compound include an organometallic compound, an organophosphorus compound, olefins and the like.

The organic compound α described above may be used alone, or a plurality of kinds thereof may be used in combination.

The solid electrolyte is not particularly limited, and examples thereof include a sulfide solid electrolyte.

The sulfide solid electrolyte is a solid electrolyte containing at least sulfur atom and exhibiting the ionic conductivity due to the contained metallic atom, and it is preferably a solid electrolyte including lithium atom and phosphorus atom in addition to sulfur atom, and more preferably lithium atom, phosphorus atom and a halogen atom, and having the ionic conductivity due to lithium atom.

The sulfide solid electrolyte may be an amorphous sulfide solid electrolyte, or it may be a crystalline sulfide solid electrolyte.

### (Amorphous Sulfide Solid Electrolyte)

The amorphous sulfide solid electrolyte contains at least sulfur atom and can be employed without any particular limitation as long as it exhibits ionic conductivity caused by the contained metal atom, and typical examples thereof preferably include a solid electrolyte such as Li₂S—P₂S₅ composed of lithium sulfide and phosphorus sulfide and containing sulfur atom, lithium atom and phosphorus atom; a solid electrolyte such as Li₂S—P₂S₅-Lil, Li₂S—P₂S₅—LiCI, Li₂S—P₂S₅—LiBr and Li₂S—P₂S₅—Lil—LiBr composed of lithium sulfide, phosphorus sulfide, and lithium halide; and a solid electrolyte containing other elements such as oxygen element and silicon element, for example, such as Li₂S—P₂S₅—Li₂O—Lil and Li₂S—SiS₂—P₂S₅—Lil. From the viewpoint of obtaining higher ionic conductivity, the solid electrolyte such as Li₂S—P₂S₅—Lil, Li₂S—P₂S₅—LiCl, Li₂S—P₂S₅—LiBr, Li₂S—P₂S₅—Lil—LiBr composed of lithium sulfide, phosphorus sulfide, and lithium halide, is preferable.

The kind of the element constituting the amorphous sulfide solid electrolyte can be confirmed by, for example, an ICP emission spectrometer.

When the amorphous sulfide solid electrolyte has at least a Li₂S—P₂S₅, the molar ratio of Li₂S to P₂S₅ is preferably 65 to 85:15 to 35, more preferably 70 to 80:20 to 30, and still more preferably 72 to 78:22 to 28, from the viewpoint of obtaining higher ionic conductivity with high chemical stability.

When the amorphous sulfide solid electrolyte is, for example, Li₂S—P₂S₅—Lil—LiBr, the total amount of lithium sulfide and phosphorus pentasulfide is preferably 60 to 95 mol%, more preferably 65 to 90 mol %, and still more preferably 70 to 85 mol %. The amount of lithium bromide is preferably 1 to 99 mol %, more preferably 20 to 90 mol %, still more preferably 40 to 80 mol %, and particularly preferably 50 to 70 mol %, based on the total amount of lithium bromide and lithium iodide.

In the amorphous sulfide solid electrolyte, when lithium atom, sulfur atom, phosphorus atom, and the halogen atom are contained, the blending proportion (molar proportion) of these atoms is preferably 1.0 to 1.8:1.0 to 2.0:0.1 to 0.8:0.01 to 0.6, more preferably 1.1 to 1.7:1.2 to 1.8:0.2 to 0.6:0.05 to 0.5, and still more preferably 1.2 to 1.6:1.3 to 1.7:0.25 to 0.5:0.08 to 0.4.

Also, when bromine and iodine are used in combination as the halogen atom, the blending proportion (molar proportion) of lithium atom, sulfur atom, phosphorus atom, bromine atom, and iodine atom is preferably 1.0 to 1.8:1.0 to 2.0:0.1 to 0.8:0.01 to 0.3:0.01 to 0.3, more preferably 1.1 to 1.7:1.2 to 1.8:0.2 to 0.6:0.02 to 0.25:0.02 to 0.25, and more preferably 1.2 to 1.6:1.3 to 1.7:0.25 to 0.5:0.03 to 0.2:0.03 to 0.2, and still more preferably is 1.35 to 1.45:1.4 to 1.7:0.3 to 0.45:0.04 to 0.18:0.04 to 0.18. When the blending proportion (molar proportion) of lithium atom, sulfur atom, phosphorus atom and the halogen atom is within the above range, it is easy to obtain a solid electrolyte having a higher ionic conductivity having a thio-LISICON Region II type crystalline structure, which will be described later.

The form of the amorphous sulfide solid electrolyte is not particularly limited, and examples thereof include particulate forms. The average particle size (D₅₀) of the particulate amorphous sulfide solid electrolyte may be, for example, in the range of 0.01 μm to 500 μm and 0.1 to 200 μm.

In the present specification, the average particle diameter (D₅₀) is a particle diameter that reaches 50% of the total by sequential integration of the particles having the smallest particle diameter when the particle diameter distribution integration curve is drawn, and the volume distribution is an average particle diameter that can be measured using, for example, a laser diffraction/scattering particle diameter distribution measuring device.

### (Crystalline Sulfide Solid Electrolyte)

The crystalline sulfide solid electrolyte may be, for example, a so-called glass ceramic obtained by heating the amorphous sulfide solid electrolyte above to a crystallization temperature or higher, and a sulfide solid electrolyte having the following crystal structure may be used.

Examples of the crystalline structure that can be possessed by the crystalline sulfide solid electrolyte containing lithium atom, sulfur atom, and phosphorus atom include a Li₇PS₄ crystalline structure, a Li₄P₂S₆ crystalline structure, a Li₇PS₆ crystalline structure, a Li₇P₃S₁₁ crystalline structure, and a crystalline structure having peaks in the vicinity of 2θ=20.2° and in the vicinity of 23.6° (for example, JP 2013-16423 A).

Examples of the crystalline structure that can be possessed by the crystalline sulfide solid electrolyte containing lithium atom, sulfur atom, phosphorus atom and the halogen atom include a Li₄₋ₓGe₁₋ₓPₓS₄ thio-LISICON Region II type crystalline structure (see Kanno et al., Journal of The Electrochemical Society, 148 (7) A742-746 (2001)), a crystalline structure similar to that of Li₄₋ₓGe₁₋ₓPₓS₄ thio-LISICON Region II type (see Solid State Ionics, 177 (2006), 2721-2725), and the like. Here, it is indicated that the “thio-LISICON Region II type crystalline structure” is any of Li₄₋ₓGe₁₋ₓPₓS₄ system thio-LISICON Region II type crystalline structure or a crystalline structure similar to Li₄₋ₓGe₁₋ₓPₓS₄ system thio-LISICON Region II type.

In X-ray diffraction measurement using CuKa rays, diffraction peaks of Li₃PS₄ crystalline structure appear, for example, around 2θ=17.5°, 18.3°, 26.1°, 27.3°, and 30.0°, diffraction peaks of Li₄P₂S₆ crystalline structure appear, for example, around 2θ=16.9°, 27.1°, and 32.5°, diffraction peaks of Li₇PS₆ crystalline structure appear, for example, around 2θ=15.3°, 25.2°, 29.6°, and 31.0°,diffraction peaks of Li₇P₃S₁₁ crystalline structure appear, for example, around 2θ=17.8°, 18.5°, 19.7°,21.8°, 23.7°, 25.9°, 29.6°, and 30.0°, diffraction peaks of Li₄₋ₓGe₁₋ₓPₓS₄ system thio-LISICON Region II type crystalline structure appear, for example, around 2θ=20.1°, 23.9°, and 29.5°, and diffraction peaks of the crystalline structure similar to Li₄₋ₓGe₁₋ₓPₓS₄ system thio-LISICON Region II type crystalline structure appear, for example, around 2θ=20.2°and 23.6°. The peak position may be about ±0.5°.

In addition, examples of the crystalline structure of the crystalline sulfide solid electrolyte also include argyrodite type crystalline structure. Examples of argyrodite type crystalline structure include a Li₇PS₆ crystalline structure; crystalline structures represented by compositional formulas represented by Li₇₋ₓP_{1-y}Si_{y}S₆ and Li₇₊ₓP_{1-y}Si_{y}S₆ (x is −0.6 to 0.6, y is 0.1 to 0.6) having a Li₇PS₆ structural skeleton; a crystalline structure represented by Li_{7-x-2y}PS_{6-x-y}Clₓ (0.8≤x≤1.7, 0<y≤−0.25x+0.5); and a crystalline structure represented by Li₇₋ₓPS₆₋ₓHaₓ (Ha is Cl or Br, and x is preferably 0.2 to 1.8).

Among the above crystalline structures, the crystalline structure of the crystalline sulfide solid electrolyte is preferably a Li₃PS₄ crystalline structure, a thio-LISICON Region II crystalline structure, or an argyrodite type crystalline structure.

The form of the crystalline sulfide solid electrolyte is not particularly limited, and examples thereof include particulate forms. The average particle size (D₅₀) of the particulate crystalline sulfide solid electrolyte may be, for example, in the range of 0.01 μm to 500 μm and 0.1 to 200 μm, similar to the average particle size (D₅₀) of the amorphous sulfide solid electrolyte described above.

The conductive aid may be a material having electronic conductivity, and it is preferably a carbon material.

The conductive aid preferably has a plurality of pores. It is particularly preferably a carbon material having pores. The carbon material is highly conductive and lighter than other conductive materials so that the power density per weight of the battery can be increased.

The BET specific surface area of the conductive aid is more preferably 0.1 m²/g or more and 6,000 m²/g or less, still more preferably 1 m²/g or more and 5,000 m²/g or less, still more preferably 1 m²/g or more and 4,000 m²/g or less, and most preferably 10 m²/g or more and 4,000 m²/g or less.

The pore volume of the conductive aid is preferably 0.1 cc/g or more and 6.0 cc/g or less.

The pores of the conductive aid preferably have an average diameter of 0.1 nm or more and 40 nm or less, more preferably 0.5 nm or more and 40 nm or less, still more preferably 0.5 nm or more and 20 nm or less, and most preferably 0.7 nm or more and 20 nm or less.

The BET specific surface area of the conductive aid, the average diameter of the pores thereof, and the pore volume thereof can be measured using a nitrogen adsorption isotherm obtained by adsorbing nitrogen gas onto the conductive aid under liquid nitrogen. Specifically, the BET specific surface area can be obtained by the Brenauer-Emmet-Telle (BET) method, and the average diameter and pore volume of the pores can be obtained by the BJH (Barrett-Joyner-Halenda) method.

As the measuring device, for example, it can be measured using a specific surface area and pore distribution measuring device (Autosorb-3) manufactured by Quantacrome.

The carbon material is not limited, but examples thereof include carbon black such as Ketjen black, acetylene black, Denca black, thermal black and channel black, mesoporous carbon, activated carbon, amorphous carbon, carbon nanotubes, carbon nanohorns, and the like, and further examples of the conductive carbon material include fullerene, carbon fiber, natural graphite, artificial graphite, and the like. These may be used alone, or two or more of them may be used in combination. Also, a composite of them can be used.

A mesoporous carbon is a carbon material having pores in two dimensions or three dimensions obtained by the process described in the following documents: for example, S. J. Sang, S. H. Joo, R. Ryoo, et., J. Am. Chem. Soc., 122 (2000) 10712-10713, and T. Yokoi, Y. Sakamoto, O. Terasaki, et., J. Am. Chem. Soc., 128 (2006) 13664-13665.

In one embodiment, the positive electrode mixture may or may not include other component other than the elemental sulfur, the solid electrolyte, the conductive aid and the organic compound α.

The other component is not particularly limited, and examples thereof include a solvent, a dispersant, a binder, and the like.

The amounts of the elemental sulfur, the solid electrolyte, the conductive aid, the organic compound α and the other component are not particularly limited in the positive electrode mixture.

In one embodiment, the amount of the elemental sulfur is 20 to 80% by mass based on the total amount thereof.

In one embodiment, the amount of the solid electrolyte is 5 to 50% by mass based on the total amount thereof.

In one embodiment, the amount of the conductive aid is 5 to 30% by mass based on the total amount thereof.

In one embodiment, the amount of the organic compound α is 0.1 to 10% by mass based on 100% by mass of the solid electrolyte.

In one embodiment, the amount of the other component is 0.1 to 10% by mass based on the total amount thereof.

In one embodiment, 50% by mass or more, 60% by mass or more, 70% by mass or more, 80% by mass or more, 90% by mass or more, 95% by mass or more, 99% by mass or more, 99.5% by mass or more, or substantially 100% by mass of the positive electrode mixture is the elemental sulfur, the solid electrolyte, the conductive aid and the organic compound 60 . When “substantially 100% by mass” thereof is formed of those materials, it may contain an inevitable impurity.

### 2. Lithium-Ion Battery

The lithium-ion battery according to an aspect of the present invention includes the positive electrode mixture according to an aspect of the present invention described above.

According to lithium-ion battery of an aspect of the present invention, it is possible to suppress the vaporization of the sulfur during production.

The positive electrode mixture can be used as a positive electrode layer of the lithium-ion battery. In this case, a known configuration can be used as other configuration of the lithium-ion battery in the present technical field, and a negative electrode layer in which the negative electrode active material does not contain lithium-ion can be used.

The negative electrode active material included in the negative electrode layer of the lithium-ion battery may be “a negative electrode active material containing lithium-ion”. In addition, the negative electrode active material included in the negative electrode layer of the lithium-ion battery may be “a negative electrode active material that supplies lithium-ion to a positive electrode”.

The negative electrode of the lithium-ion battery is not particularly limited as long as it can be used in ordinary battery. The negative electrode may be formed of a negative electrode mixture obtained by mixing the negative electrode active material and the solid electrolyte.

As the negative electrode active material, commercially available ones can be used. For example, carbon material, Sn metal, In metal, Si metal, alloys of these metals, and the like can be used. Specific examples thereof include natural graphite, various types of graphite, a metal powder such as and Si, Sn, Al, Sb, Zn and Bi, a metal alloy such as SiAl, Sn5Cu6, Sn₂Co and Sn₂Fe, others such as an amorphous alloy and a plated alloy. Although there is no particular limitation on the particle size, those having an average particle size of several um to 80 μm can be suitably used.

The electrolyte layer is not particularly limited, and a known electrolyte layer can be used. For example, an oxide-based solid electrolyte, a sulfide-based solid electrolyte, and a polymer electrolyte is preferable, and a sulfide-based solid electrolyte is more preferable from the viewpoint of ionic conductivity. The sulfide-based solid electrolyte is preferably used for the positive electrode mixture described above.

The method for producing the lithium-ion battery is not particularly limited. For example, a method in which a solid electrolyte layer is formed on a sheet in which the positive electrode layer made of the positive electrode mixture according to an aspect of the present invention is formed on a positive electrode current collector, a sheet having the negative electrode layer formed on a negative electrode current collector in advance is stacked thereon, and then they are pressed, and the like can be given.

### 3. Composition for Positive Electrode Mixture

A composition for the positive electrode mixture according to an aspect of the present invention includes an elemental sulfur, a solid electrolyte, a conductive aid, an organic compound (organic compound α) capable of suppressing the vaporization of the elemental sulfur, and a solvent.

For the solid electrolyte, the conductive aid, and the organic compound α included in the composition for the positive electrode mixture, the description given for the positive electrode mixture according to an aspect of the present invention is applicable.

The solvent is not particularly limited, and examples thereof include a fluorine solvent, a hydrocarbon solvent, and a thio solvent, and specific examples thereof include fluorine carbide, fluorobenzene, trifluoromethylbenzene, bistrifluoromethylbenzene, benzene, toluene, xylene, thiol, and the like.

The solid concentration of the composition for the positive electrode mixture is, for example, 20% by weight or more and 95% by weight or less, and preferably 30% by weight or more and 85% by weight or less.

### 4. Method for Producing Positive Electrode Mixture

A method for producing the positive electrode mixture according to an aspect of the present invention includes: heating the above-described composition for the positive electrode mixture according to an aspect of the present invention.

When the composition for the positive electrode mixture is heated, the solvent included in the composition for the positive electrode mixture is dried and removed to obtain the positive electrode mixture. When the composition for the positive electrode mixture according to an aspect of the present invention is used, it is possible to suppress the vaporization of the sulfur even in the case where such a dry operation is conducted.

The heating temperature is not particularly limited, but is, for example, 50 to 200 °C. The heating time is not particularly limited, but is, for example, 0.1 to 120 minutes. It is preferable that it be heated under reduced pressure or under an inert gas atmosphere.

In one embodiment, the composition for the positive electrode mixture (as a coating liquid) is coated on an optional substrate (for example, a positive electrode current collector), it is heated, the solvent is removed by drying to obtain the positive electrode mixture. The positive electrode mixture thus obtained may be in the form of, for example, a sheet-like form, and it may form the positive electrode layer of the lithium-ion battery described above.

### EXAMPLES

Examples of the present invention are described below, but the present invention is not limited by these Examples.

### Example 1

### (1) Preparation of Solid Electrolyte A

15.3 g of lithium sulfide and 24.7 g of phosphorus pentasulfide were added to a 1 L of reaction vessel equipped with a stirring blade under a nitrogen atmosphere, the stirring blade was operated, and then 400 mL of tetrahydrofuran cooled to −20 °C was added to the vessel. The temperature thereof was naturally increased to room temperature, and then the stirring was continued for 72 hours. The obtained reaction solution slurry was subjected to a glass filter (pore size: 40 to 100 μm) to obtain a solid content, and then the solid content was dried at 90 °C to obtain a Li₃PS₄ powder (purity: 90% by mass). 1.70 g of the obtained Li₃PS₄ powder, 0.19 g of lithium bromide, and 0.28 g of lithium iodide were added to a Schlenk bottle (volume: 100 mL) with a stirrer bar under a nitrogen atmosphere. The stirrer bar was rotated, and then 20 mL of tetramethylethylenediamine (TMEDA) being a complexing agent was added thereto. The stirring was continued for 12 hours, and then obtained electrolyte precursor content was dried at room temperature in a vacuum to obtain a powder of electrolyte precursor. The resulting electrolyte precursor was heated in a vacuum at 120 °C for two hours, and it was further heated in a vacuum at 140 °C for two hours to obtain solid electrolyte A.

A portion of the obtained solid electrolyte A was dissolved in methanol, and the obtained methanol solution was analyzed by gas chromatography to measure the amount of tetramethylethylenediamine. The amount of the complexing agent was 1.2% by mass in the solid electrolyte.

### (2) Preparation of Positive Electrode Mixture A

An activated carbon (MSC-30, manufactured by Kansai Coke and Chemicals Company, Limited) and an elemental sulfur were added to a glass tube at a mass ratio of 30:70, and then it was sealed in a SUS tube container. It was heated using an electric furnace at 150 °C for 6 hours, and then at 300 °C for 2.75 hours to obtain composite powder A of the activated carbon and the elemental sulfur. 0.45 g of the obtained composite powder A and 0.45 g of the solid electrolyte A, together with ten zirconia balls having the diameter of 10 mm, were added to a 45 mL of zirconia pot, and it was sealed. Mixing treatment was conducted at room temperature for 20 hours at a rotational speed of 370 rpm by using a planetary ball mill apparatus (manufactured by Fritsch GmbH, model number P-7) to obtain positive electrode mixture A.

### Evaluation Method

### Generated Gas Analysis

A glass tube was filled with 5 mg of the obtained positive electrode mixture in the glove box, and the end of the glass tube was sealed. The glass tube filled with the positive electrode mixture was taken out from the glove box, it was mounted on a On line Microreaction Sampler (manufactured by Frontier Laboratories Ltd.), and they were introduced into the pyrolizer. The gases generated by heating the positive electrode mixture were detected on-line by a gas chromatograph mass spectrometer (GCMS). The device used for the measurement, the heating conditions of the pyrolysis furnace, and GCMS conditions are as follows.

### Device Used

Pyrolizer: EGA/PY-3030D (manufactured by Frontier Laboratories Ltd.)
Gas chromatograph mass spectrometer: 8890/5977B (manufactured by Agilent Technologies, Inc.)
Column: capillary tube for EGA (length of 2.5 m×inner diameter of 0.15 mm) (manufactured by Frontier Laboratories Ltd.)

### Heating Conditions of Pyrolysis Furnace

50 °C→temperature increase of 10 °C/min→600 °C (5 min holding)

### GCMS conditions

Carrier gas (He) flow rate: 1 mL/min
Split ratio: 10:1
Inject port temperature: 300 °C
Oven: 300 °C (constant)
Ion source temperature: 300 °C

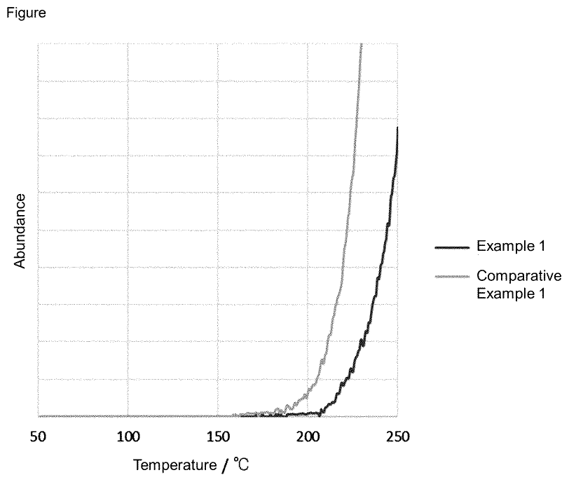

The generated gas analysis results are shown in FIG. 1.

### Comparative Example 1

### (1) Preparation of Solid Electrolyte B

0.4127 g of lithium sulfide, 0.6655 g of phosphorus pentasulfide, 0.2137 g of lithium iodide, 0.2080 g of lithium bromide and ten zirconia balls having the diameter of 10 mm were added to a 45 mL of zirconia pot, and it was sealed. Mixing treatment (mechanical milling) was conducted for 40 hours at a rotational speed of 370 rpm by using a planetary ball mill apparatus (manufactured by Fritsch GmbH, model number P-7) to obtained a powder. The obtained powder was heated at 195 °C for 3 hours to obtain a solid electrolyte B. The obtained solid electrolyte B does not contain tetramethylethylenediamine.

### (2) Preparation of Positive Electrode Mixture B

A positive electrode mixture B was obtained under the same preparation conditions as in “(2) Preparation of positive electrode mixture A” of Example 1, except that the electrolyte used was a solid electrolyte B.

The resulting positive electrode mixture B was subjected to generating gas analysis in the same manner as in Example 1. The analysis results from 50 °C to 250 °C are shown in FIG. 1.

### Evaluation

As seen from FIG. 1, when comparing the amount of generated gas of elemental sulfur at 200 °C between the positive electrode mixture A containing an organic compound (here, tetramethylethylenediamine) capable of suppressing the vaporization of elemental sulfur and the positive electrode mixture B containing no elemental sulfur, it was confirmed that the amount of generated gas of the positive electrode mixture A was about ⅛ as compared to that of the positive electrode mixture B, and therefore, sulfur was hardly vaporized. Accordingly, it is considered that when the positive electrode mixture A was applied by dispersing it as a material of the positive electrode sheet in a solvent and it was dried, the sulfur was less likely to be vaporized.

### INDUSTRIAL APPLICABILITY

The positive electrode mixture of the present invention is suitable as the positive electrode of the lithium-ion battery. In addition, the lithium-ion battery of the present invention is suitably used for, for example, a battery and the like used in an information-related device and a communication device such as a personal computer, a video camera and a mobile phone, a vehicle such as an electric vehicle.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. A positive electrode mixture comprising an elemental sulfur, a solid electrolyte, a conductive aid, and an organic compound capable of suppressing the vaporization of the elemental sulfur.

2. The positive electrode mixture according to claim 1, wherein the organic compound comprises N (nitrogen atom) and has an unshared electron pair.

3. The positive electrode mixture according to claim 1, wherein the organic compound is an amine.

4. The positive electrode mixture according to claim 1, wherein the organic compound is an aliphatic amine.

5. The positive electrode mixture according to claim 1, wherein the organic compound has a tertiary amino group.

6. The positive electrode mixture according to claim 1, wherein the organic compound is tetramethylethylenediamine.

7. The positive electrode mixture according to claim 1, wherein the solid electrolyte is a sulfide solid electrolyte.

8. A lithium-ion battery comprising the positive electrode mixture according to claim 1.

9. A composition for a positive electrode mixture comprising an elemental sulfur, a solid electrolyte, a conductive aid, an organic compound capable of suppressing the vaporization of the elemental sulfur, and a solvent.

10. A method for producing a positive electrode mixture, comprising: heating the composition for the positive electrode mixture according to claim 9.
